(19) United States
(12) Patent Application Publication
(10) Pub. No.: US 2026/0344644 A1
(43) Pub. Date: Nov. 5, 2026

(54) AN APPARATUS FOR SUPPLYING FLUID FROM A FLUID SOURCE TO A CONTAINER

(71) Applicant: UPL LIMITED, Mumbai (IN)

(72) Inventor: Pushpaksen P. ASHER, Pereiras (BR)

(21) Appl. No.: 19/109,190

(22) PCT Filed: Sep. 6, 2023
(86) PCT No.: PCT/IB2023/058806

§ 371 Date: Mar. 6, 2025

(30) Foreign Application Priority Data
Sep. 6, 2022 (IN) 202221050777

(51) Int. Cl. B65D 88/74; A23B 2/704

(52) U.S. Cl. CPC B65D 88/745; A23B 2/704; B65D 2588/746

(57) ABSTRACT

An apparatus for supplying fluid t from a fluid source to a container is disclosed. The apparatus includes a dispending head configured to be removably secured to an outer surface of a container. The apparatus is configured to cover at least one port defined in a wall of the container. The dispensing head is defined with a cavity in fluid communication with the at least one port and is configured to receive and supply the fluid from the fluid source. The apparatus includes a coupling mechanism adapted to removably secure the dispensing head on the outer surface of the container. The mechanism includes an elongated support member adapted to adjustably receive the dispending head. Further, a coupler is provided on either ends of the elongated support member. The coupler along with the elongated support member is configured to hold dispensing head abutting the at least one port.

### TECHNICAL FIELD

Present disclosure relates to a field of pest control systems. Particularly, but not exclusively, the present disclosure relates to an apparatus and a system for supplying fluid. Further, embodiments of the present disclosure relate to an apparatus and system for supplying fluid to a container carrying commodities.

### BACKGROUND

The information disclosed in this background is only for enhancement of understanding of the general background of the invention and should not be taken as an acknowledgement or any form of suggestion that this information forms the prior art already known to a person skilled in the art. The background henceforth is explained with an exemplary scenario referring to fumigation of containers.

Transport of materials and goods is a vital process for commerce. This transport requires efficiency to minimize impacts on manpower, time and costs. One commonly employed solution for long distance shipping is the use of cargo containers. The containerization of cargo has transformed the shipping industry by increasing efficiency through the creation of standardized shipping containers that are designed for movement through all major modes of transportation, including cargo ships, trucks, and railroad cars. Due to such increases in efficiency, and improvement in refrigerated shipping container designs, a wide variety of products, are now shipped throughout the world. With an increase in the availability of a wide range of products, including perishable items, the risk of transporting harmful pests along with the shipped goods also is enhanced. Foreign pests/insects/micro-organism often have the potential of endangering commodities. Therefore, it is necessary to sterilize/disinfect the containers during and after shipping. There are conventional techniques that are employed for sterilizing or disinfecting the containers. Available techniques include spraying of sterilizing/disinfecting fluids manually into the containers. The fluids can be chemical reagents including fumigants for fumigation of containers. However, such conventional techniques include myriad disadvantages and also require involvement of humans and is time consuming.

It is common practice to fumigate prior to shipment. Fumigation of stored agricultural produce and other commodities is preferred to prevent damages caused by pests. Typically, fumigation is achieved by introducing fumigants in the form of pellets, tablets, bags, or plates containing directly into the container to be fumigated. The fumigant reacts with the ambient moisture in the agricultural produce and/or commodity, resulting in the generation of gas [i.e., liberated from the fumigant].

Fumigation processes for bulky materials, agricultural produce, and manufactured goods, as well as for shipping containers themselves are known in the art. These processes involve placement of a heavy, impervious blanket or other covering article over the materials to be fumigated followed by subsequent addition of toxic gas flow under the blanket to fumigate the covered goods. Current apparatus and methods of fumigation under blankets are crude, ineffective at fully eliminating insect infestation since gas distribution may not be uniform for effective pest control. Subsequent atmospheric discharges of fumigant gases, for example methyl bromide is highly undesirable because such gases are ozone depleting. If adequate aeration is not provided, it presents a danger during later occupational contact with these goods. In addition to above, handling and operating the conventional fumigation devices for fumigating the containers poses a significant challenge to operators. Hence, there is a need for efficient system for fumigating shipping containers.

As a result of myriad disadvantages present with the conventional fumigation process using blankets, other conventional systems and/or methods have been developed. One such method for fumigating produce includes a vented container in which the produce is stored. The vented container is stacked in a purpose-built fumigation chamber of a fumigation facility and the produce is fumigated with gaseous fumigant. The containers are then transported out of the fumigation facility either to a cold storage or packing house. Other conventional setups include use of bags or sachets prepacked with fumigant solids, which when removed from their shipping containers and exposed to atmospheric air will liberate fumigant. These sachets are manually inserted into the container in a uniform fashion after the depository is filled. The conventional methods are quite laborious, time consuming and can be unsafe. Fumigants currently in use leave residues in the container which must be withdrawn at destination.

The present disclosure is directed to overcome one or more limitations stated above or any other limitations associated with the conventional systems.

The information disclosed in this background of the disclosure section is only for enhancement of understanding of the general background of the invention and should not be taken as an acknowledgement or any form of suggestion that this information forms the prior art already known to a person skilled in the art.

### SUMMARY OF THE DISCLOSURE

One or more shortcomings of the prior art are overcome by a system and a method as disclosed and additional advantages are provided through the apparatus and the system as described in the present disclosure.

Additional features and advantages are realized through the techniques of the present disclosure. Other embodiments and aspects of the disclosure are described in detail herein and are considered a part of the disclosure.

In one non-limiting embodiment of the disclosure, an apparatus for supplying fluid from a fluid source to a container is disclosed. The apparatus according to the present disclosure includes a dispensing head configured to be removably secured to an outer surface of the container. The dispensing head is defined with a cavity in fluid communication with the at least one port and is configured to receive and supply the fluid from a fluid source to the container. The apparatus further includes a coupling mechanism adapted to removably secure the dispensing head on the outer surface of the container. The coupling mechanism includes an elongated support member adapted to adjustably receive the dispending head. Further, a coupler is provided on either ends of the elongated support member. The coupler along with the elongated support member holds dispensing head abutting the at least one port.

In an embodiment of the disclosure, the coupler is at least one of a magnetic coupler and suction coupler.

In an embodiment of the disclosure, the dispensing head is adjustably secured to the elongated support member at a substantially central portion. Further, the elongated support member is defined with a slot on either side of the dispensing head. The coupler is received by the slot defined in the elongated support member.

In an embodiment of the disclosure, the coupler is defined with a collar. The collar is defined on each of the coupler is configured to receive a first adjuster. The collar is defined on each of the coupler and is receivable by the slot defined in the elongated support member. Each of the coupler is movable within the slot and is configured to be locked pre-defined position by the first adjuster.

In an embodiment of the disclosure, the dispensing head is adjustably secured to the elongated support member by one or more second adjusters. The one or more second adjusters are configured to adjust at least one of position and height of the dispensing head relative to the elongated support member.

In an embodiment of the disclosure, a sealing member is provided along a periphery of the dispensing head on a side securable to the at least one port.

In another non-limiting embodiment of the disclosure, a system for supplying fluid a container is disclosed. The system includes a fluid source configured to supply fluid. The system further includes an apparatus in fluid communication with the fluid source and is adapted to receive and supply fluid from the fluid source to the container. The apparatus includes a dispending head configure to be removably secured to an outer surface of a container. The dispensing head is defined with a cavity in fluid communication with the at least one port and is configured to receive and supply the fluid from a fluid source to the container. The apparatus further includes a coupling mechanism adapted to removably secure the dispensing head on the outer surface of the container. The coupling mechanism include an elongated support member adapted to adjustably receive the dispending head. Further, a coupler is provided on either ends of the elongated support member. The coupler along with the elongated support member holds dispensing head abutting the at least one port.

It is to be understood that the aspects and embodiments of the disclosure described above may be used in any combination with each other. Several of the aspects and embodiments may be combined together to form a further embodiment of the disclosure

The foregoing summary is illustrative only and is not intended to be in any way limiting. In addition to the illustrative aspects, embodiments, and features described above, further aspects, embodiments, and features will become apparent by reference to the drawings and the following description.

### BRIEF DESCRIPTION OF THE ACCOMPANYING FIGURES

The novel features and characteristics of the disclosure are set forth in the appended claims. The disclosure itself, however, as well as a preferred mode of use, further objectives, and advantages thereof, will best be understood by reference to the following detailed description of an illustrative embodiments when read in conjunction with the accompanying figures. One or more embodiments are now described, by way of example only, with reference to the accompanying figures wherein like reference numerals represent like elements and in which.

FIG. 1 illustrates a schematic view of a container and a system for supplying fluid to a container, in accordance with an embodiment of the disclosure.

FIG. 2 illustrates a side view of the container and the system for supplying fluid the container of FIG. 1.

FIG. 3 illustrates a top view of an apparatus used in the system of FIG. 1, in accordance with an embodiment of the present disclosure.

FIG. 4 illustrates a bottom view of the apparatus of FIG. 3.

FIG. 5 illustrates a front view of the apparatus of FIG. 3.

The figures depict embodiments of the disclosure for purposes of illustration only. One skilled in the art will readily recognize from the following description that alternative embodiments of the unit illustrated herein is employed without departing from the principles of the disclosure described herein.

### DETAILED DESCRIPTION

While embodiments in the disclosure are subject to various modifications and alternative forms, specific embodiments thereof have been shown by way of example in the figures and will be described below. It should be understood, however, that it is not intended to limit the disclosure to the particular form disclosed, but on the contrary, the disclosure is to cover all modifications, equivalents, and alternatives falling within the scope of the disclosure.

It is to be noted that a person skilled in the art would be motivated from the present disclosure and modify various features of bumper assembly for vehicle, without departing from the scope of the disclosure. Therefore, such modifications are considered to be part of the disclosure. Accordingly, the drawings show only those specific details that are pertinent to understand the embodiments of the present disclosure, so as not to obscure the disclosure with details that will be readily apparent to those of ordinary skilled in the art having benefit of the description herein. Also, the assembly of the present disclosure may be employed in any kind of vehicles including commercial vehicles, passenger vehicles, and the like. However, neither the vehicle nor complete frame supporting the internal combustion engine, exhaust after treatment unit of the vehicle is illustrated in the drawings of the disclosure is for the purpose of simplicity.

The terms “comprise”, “comprising”, or any other variations thereof, are intended to cover a non-exclusive inclusion, such that a system that comprises a list of components does not include only those components but may include other components not expressly listed or inherent to such mechanism. In other words, one or more elements in the apparatus or system preceded by “comprises . . . a” does not, without more constraints, preclude the existence of other elements or additional elements in the system. Further, the term of approximation such as “substantially” when used in reference to physical characteristics in the present disclosure, should be understood to contemplate a range of deviations that would be appreciated by one of ordinary skill in the art to operate satisfactorily for a corresponding use, function, purpose, or the like. The term “substantially” is a descriptive term commonly used in disclosures to avoid a strict numerical boundary to the specified parameter. The term “substantially” should be read in conjunction with the terms “perpendicular”, “central”, “circular”, “along a radius”, “vertical”, “conforming” etc.

Embodiments of the present disclosure describes an apparatus for supplying fluid from a fluid source to a container. The apparatus includes a dispensing head configured to be removably secured to an outer surface of a container and covering at least one port defined in a wall of the container. The dispensing head is defined with a cavity in fluid communication with the at least one port and may be configured to receive and support a fluid from a fluid source to the container. The apparatus includes a coupling mechanism that may be adapted to removably secure the dispensing head on the outer surface of the container. Configuration of the apparatus is described in detail in forthcoming embodiments.

In the forthcoming description of the embodiments of the disclosure, reference is made to the accompanying figures that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

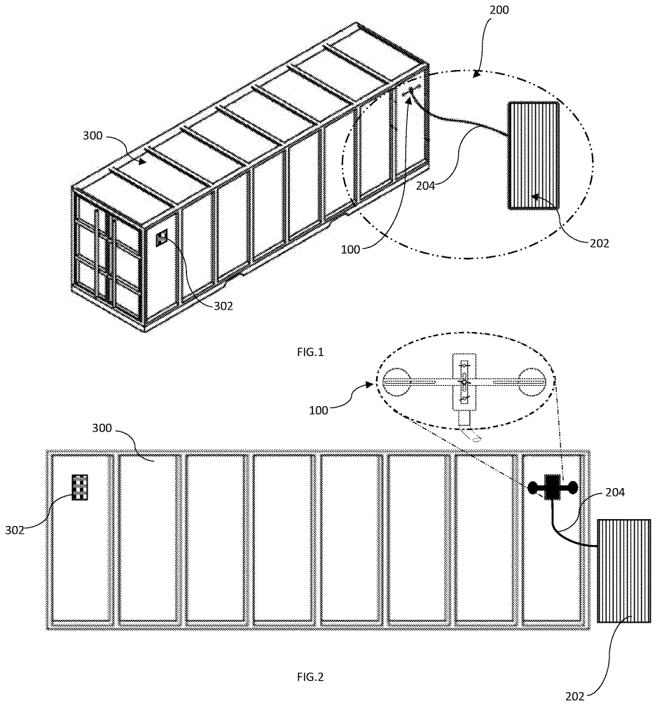

The following paragraphs describe the present disclosure with reference to FIGS. 1 to 5. In the figures, the same element or elements which have similar functions are indicated by the same reference signs. With general reference to the drawings, a system for supplying fluid to a container is identified by reference numeral 200. The system (200) includes an apparatus for supplying fluid from a fluid source to the container and is generally identified with reference numeral 100. The apparatus (100) is capable of receiving fluid from the fluid source (202) and supplying the fluid to the container (300). The system (200) and the apparatus (100) for receiving and supplying fluid is elucidated in a greater detail henceforth. For the purpose of simplicity only certain features of the system (200), in particular the apparatus (100), are depicted in the figures.

The system (200) and the apparatus (100) for supplying fluid to the container (300) from the fluid source (200) in accordance with the disclosure is explained hereinafter with a preferred embodiment of fumigating chemical formulation onto commodities such as but not limiting to agricultural produce. The commodities include but are not limited to fruits including pome, apple citrus, blueberries etc, grains including wheat, barley, rice etc, commodities including timber and vegetables including potato, beans, etc. Although, specific commodities are mentioned above, the same should not be construed as a limitation of the present disclosure. The term “commodities” embodies other goods used in commerce and those that can be shipped using the container (300). Also, the use of system (200) and apparatus (100) for supplying fluid should not be construed as a limitation of the present disclosure.

Referring to FIG. 1 and FIG. 2 in conjunction, there is provided a system (200) for supplying fluid to the container (300). In a preferred embodiment, the system (200) is adapted for fumigation of the container (300) [also referred to as shipping container and alternatively used]. The shipping container (300) is generally rectangular shaped with the standard lengths of 20′, 40′ or 45′. In an embodiment, the shipping container (300) is built around a frame [not shown].

The shipping container (300) is formed of a plurality of reinforced panel members providing a bottom or floor defining a base of the container. In an embodiment, the bottom, or the floor of the container (300) is provided with supporting feet or skids at the corners thereof. The container (300) further includes opposite side panel members, a top and end wall panel member, respectively. The opposite side panel members and the end wall panel member extends upwardly from the base of the container (300). The at least one end wall panel of the container (300) is configured as a door to access storage compartment of the container (300). The door is a single wing door or is a double wing door. In an embodiment, the door is equipped with rubber gaskets to provide seal between door and door sills, corner posts and door header. Further a sealing member is applied to prevent leakage between base, the opposite side panel members, the top and end wall panel members. In an embodiment, the opposite side panels, the end wall panels, and the top panel is corrugated thereby increasing rigidity of the container (300).

The containers (300) are defined with ports (302). The term “port” used herein after and before refers to a through opening or an aperture defined on the container for passage or escape of fluids. In an embodiment, the ports (302) are defined at the top side of the opposite side panel members as apparent from FIG. 2. The ports (302) prevent pressure build-up in case of temperature increase or release of gaseous compounds during transport as well as providing ventilation to prevent water condensation. The port (302) is also used for inducting fluid into the container (300). According to a preferred embodiment, the fluid is a fumigant for fumigation of commodities that are stored in the container (300). In the forthcoming embodiments, the system (200) for fumigating the container (300) will be elucidated in detail.

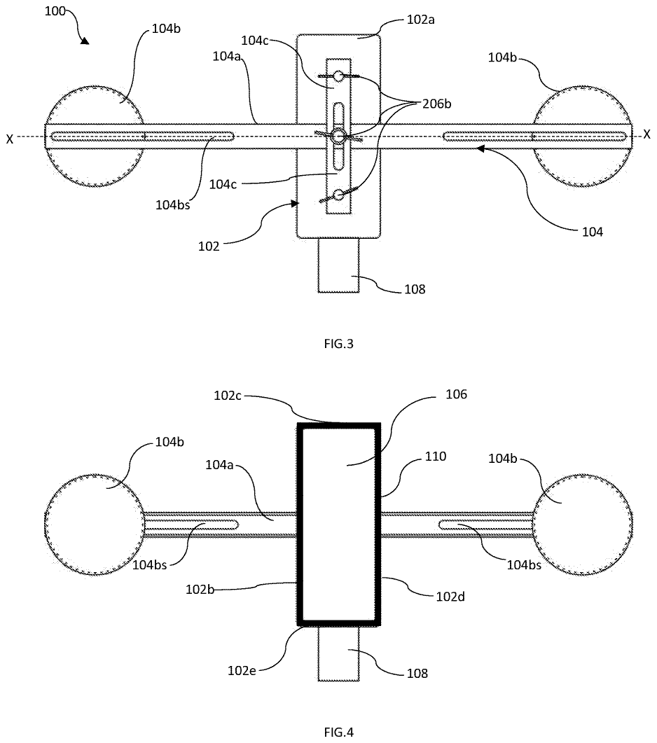

In an exemplary embodiment, the container (300) carrying commodities is fumigated using the system (200) as depicted in FIGS. 2 and 3. The term “fumigant” used hereinabove and after refers to a chemical which, at a required temperature and pressure, can exist in the gaseous state in sufficient concentration to be lethal to a given pest or organism. In an embodiment, the fumigants are liquid in their packaging which then transforms into a gas when released while some other fumigants remain as gases through formulation, packaging, and release. Other fumigants include volatile liquids when enclosed in a container and, therefore, are not formulated under pressure. Some other fumigants include solids that release gases when applied under conditions of high humidity or in presence of water vapor. The fumigants that are used for fumigating of containers (300) is at least one of but not limiting to methyl bromide, 1,3-dichloropropene, dazomet or methyl isothiocyanate, chloropicrin, Di-bromochloropropane [DBCP], formaldehyde, hydrogen cyanide, iodoform, methyl isocyanate, phosphine, sulfuryl fluoride, sulfur dioxide, aluminum phosphide, magnesium phosphide, carbon tetrachloride, carbon disulfide, ethylene dibromide, ethylene dichloride, acrylonitrile, dichloronitroethane, ethylene chlorobromide, methylene chloride, ethylene oxide, hydrogen cyanide (HCN), dichlorvos, etc. The fumigant is used for fumigation of the shipping containers (300). The term fumigating and/or fumigation used hereinabove and after in the present disclosure refers to a process where the fumigant at specific temperature and pressure can exist in gaseous state of using chemical smoke to kill pests/lethal micro-organisms.

The system (200) of the present disclosure includes a fluid source (202). The fluid source (202) is configured to contain and supply the fumigant to the container (300) via the apparatus (100). Hence, the fluid source (202) will also be referred to as the fumigant source (202) henceforth. The fluid source (202) is configured to contain various fluids and fumigant is one such fluid. The fluid source (202) is configured to generate fumigant. For example, the fluid source (202) is a phosphine gas generator configured to generate phosphine gas by mixing a metal phosphide and water. The mixture of metal phosphide and water is agitated and diluted with air to generate phosphine gas and the same is used for fumigation of containers (300). Although phosphine gas generator is illustrated above, the same should not be construed as a limitation of the present disclosure. Similar generators are used to produce hydrogen cyanide gas, chloropicrin gas etc. In an exemplary embodiment, the phosphine gas generator includes a rector configured to receive fumigant, and a liquid reservoir adapted to receive liquid such as water. The phosphine gas generator also includes an agitation air compressor to supply agitation air to the reactor, an air blowing unit to provide dilution air, a heater, a control unit, and an outlet port. Although the certain features of the phosphine gas generator are illustrated above, it is only exemplary in nature and should not be construed as a limitation of the present disclosure. The features or the components of the fluid source (202) works in tandem to generate fumigant gas that is used for fumigation of the container (300). The fumigant gas generated by the fluid source (202) is supplied to the container (300) through an apparatus (100) of the present disclosure. The fluid source (202) is fluidly connected to the apparatus (100) through a fluid supply member (204) such as but not limiting to a hose. One end of the hose (204) is connected to the outlet port [not shown] of the fluid source (202) and another end of the hose (204) is connected to an inlet port (108) of the apparatus (100). Forthcoming paragraphs elucidate the apparatus (100) in conjunction with FIGS. 3 to 5.

The apparatus (100) of the present disclosure is configured to supply fluid from the fluid source (202) to the container (300). In an embodiment, the apparatus (100) is configured to supply fumigant from the fumigant source (202) [i.e., the fluid source] to the container. The apparatus (100) includes a dispensing head (102). In an embodiment, the dispensing head (102) is a unitary structure. In some embodiments, the dispensing head (102) is formed using one or more portions. The dispensing head (102) is round, oval, square, rectangular, triangular, pentagonal, hexagonal, hepta/octagonal or irregular in shape. The shape of the dispensing head (102) corresponds to shape of the port (302) defined on the container (300). As an example, the shape of the dispensing head (102) is substantially rectangular.

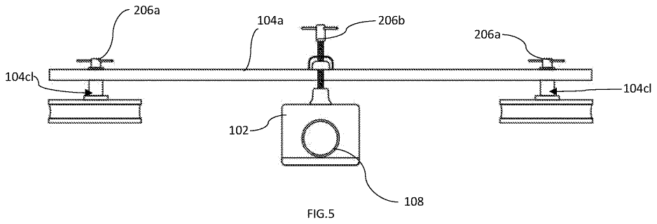

The dispensing head (102) includes a base member (102a) and a sidewall structure (102b, 102c, 102d, 102e) extending substantially perpendicular to the base member (102a) and defining a cavity (106) [refer FIG. 4] therebetween. The sidewall structure (102b, 102c, 102d, 102e) includes a first and second major sidewall (102b and 102d) and a first and second minor sidewall (102c and 102e). The first and second major sidewall (102b and 102d) and the first minor sidewall (102c and 102e) is referred to in context with dimension of the sidewall of the rectangular shaped dispensing head (102) and hence should not be construed as a limitation. Each sidewall (102b, 102c, 102d and 102e) is joined to another defining a corner. In some instances, the corners connecting base member (102a) and the sidewall structure (102b, 102c, 102d, 102e) is rounded or defined with a fillet. In a preferred embodiment, the sidewall structure (102b, 102c, 102d and 102e) and the base member (102a) is a unitary structure. In other embodiments, the sidewall structure (102b, 102c, 102d and 102e) and the base member (102a) is integrated mechanical or thermal joining means including but not limiting to crimping or seam welding respectively. The dispensing head (102) of the above configuration is defined with an open-end opposite to the end of the dispensing head (102) having the base member (102a). A periphery of the open end of the dispensing head (102) is adapted to receive a sealing member (110) [refer FIG. 4]. The term “sealing member” refers to a device that is configured to join system or mechanisms together by preventing leakage, containing pressure, or exclude contamination. The sealing member (110) is at least one of gasket, bellow seals, or other suitable sealing members. In some embodiments, the sealing member (110) is at made of at least one of but not limiting to rubber or plastic. In an embodiment, the open end is defined with a planar flange [not shown] extending perpendicularly outward from the periphery of the sidewall structure (102b, 102c, 102d, 102e). The planar flange is adapted to receive and support the sealing member (110). The sealing member (110) provided along the periphery of the dispensing head (102) ensures that there is no leakage of gas when the dispensing head (102) is mounted on an outer surface of the container (102) covering the at least one port (302). Further, the dispensing head (102) is defined with the inlet port (110) as illustrated earlier in the present disclosure. The inlet port (110) is defined on the at least one sidewall of the sidewall structure (102b, 102c, 102d, 102e). The inlet port (110) is adapted to receive another end of the hose (204) carrying fumigant from the fumigant source (202).

The dispensing head (102) of the configuration as described above is removably secured to an outer surface of the container (300). In an embodiment, a coupling mechanism (104) is provided along with the dispensing head (102) to removably secure the dispensing head (102) on the outer surface of the container (300). The term “mechanism” refers to an assembly of parts performing a complete functional motion, often being part of a linkage or a structure or arrangement of parts of a device, or of anything analogous. The dispensing head (102) is removably secured to the outer surface of the container (300) such that the cavity (106) of the dispensing head (102) is in fluid communication with the at least one port (302) as depicted in FIG. 2. The periphery of the open end of the dispensing head (102) abuts against a boundary of the at least one port (302). The cavity (106) is configured to receive fumigant from the fumigant source (202) through the hose (204) connected to the inlet port (108). The fumigant is then supplied into the container (300) for fumigation through the at least one port (106). The sealing member (110) provided on the periphery of the dispensing head (102) ensures that the fumigant passing through the dispensing head (102) to the container (300) does not leak. The coupling mechanism (104) adapted to secure the dispensing head (102) to the outer surface of the container (300) is elucidated in the forthcoming paragraphs.

The coupling mechanism (104) includes an elongated member (104a). The elongated support member (104) [also referred to as elongated member and used alternatively hereinafter] having a longitudinal axis (X-X) and extend with a longitudinal length and a width, which dimensions provides a generally rectangular shape [refer FIG. 3]. Further, the elongated member (104) includes a planar or flat configuration that defines a depth or thickness. As shown in FIG. 3, the elongated member (104) is defined with a slot proximal to either ends of the elongated member (104). The slots defined in the elongated member (104) extends up to a pre-defined length along the longitudinal axis (X-X). In an embodiment, the elongated member (104) further includes a cross member (104c). The cross member (104c) is provided at a substantially central portion of the elongated member (104a) and extends in a transverse direction relative to the longitudinal axis (X-X). In an embodiment, the cross member (104c) is integrally defined on the elongated member (104). In another embodiment, the cross member (104c) is positioned on to the central portion of the elongated member (104a) and is joined by known mechanical or thermal joining process.

The elongated support member (104a) is configured to adjustably receive the dispensing head (102) of the present disclosure. In an embodiment, the dispensing head (102) is secured to the elongated member (104a) at a substantially central portion. One or more second adjusters (206b) are used to adjustably secure the dispensing head (102) to the elongated support member (104a). In an embodiment, the one or more second adjusters (206b) are received by the cross member (104c) defined on the elongated support member (104a). The dispensing head (102) is adjustably secured to the cross member (104c). The one or more second adjusters (206) are an adjuster screw but not limiting to the same. The one or more second adjusters are receivable by a collar [not shown] defined on the dispensing head (102). Using the one or more second adjusters (206b), at least one of position and height of the dispensing head (102) is adjusted. That is, the one or more second adjusters (206) can be unscrewed/unfastened to move the dispending head (102) towards or away from the elongated member (104a). Similarly, the dispensing head (102) can be displaced in the perpendicular direction with respect to the longitudinal axis (X-X) upon unfastening the one or more second adjusters (206b). Once the desired height and position is achieved relative to the elongated member (104a), the one or more second adjusters (206b) are fastened thereby securing the dispensing head (102) relative to the elongated member (104a). Adjusting at least one of the height or position of the dispending head (102) enables appropriate positioning of the dispensing head (102) relative to the at least one port (302).

The coupling mechanism (104) further includes a coupler (104b) [as shown in FIGS. 2 to 4]. The coupler (104b) is selected from a magnetic coupler and a suction coupler but not limiting to the same. According to the preferred embodiment of the present disclosure, the coupler (104b) is a magnetic coupler. In an embodiment, the magnetic coupler (104b) is made of strong magnets including neodymium, samarium-cobalt magnets but not limiting to the same. In another embodiment, the magnetic coupler (104b) is an electro-magnet. The coupler (104b) is provided on either ends of the elongated support member (104a) i.e., on either side of the dispensing head (102). The coupler (104b) is receivable by the slot defined in the elongated support member (104a). The coupler (104b) is movable within the slot defined in the elongated member (104b). The coupler (104b) is movably securable to the elongated support member (104a) using a first adjuster (206a) [refer FIG. 5]. In an embodiment, the coupler (104b) is defined with a collar (104cl) configured to receive the first adjuster (206a). The term “collar” here refers to a projection extending perpendicularly from a surface of the coupler (104b). The collar (104cl) is ingressed into the slot and the first adjuster (206a) is screwed to the collar (104cl), thereby securing the coupler (104b) within the slot. Although, collar is defined, the same should not be construed as a limitation of the present disclosure, other means of receiving the first adjuster (206a) can also be provided. In an embodiment, the collar (104cl) can be unified with the coupler (104b). in another embodiment, the collar (104cl) can be connected to the coupler by at least one of mechanical and/or thermal joining process. The first adjuster (206a) can be operated to adjust the position of the coupler (104b) within the slot. For instance, the first adjuster (206a) can be unfastened from the coupler (104b) thereby allowing it to be displaced within the slot i.e., towards the dispensing head (102) or away from it. Once the pre-defined position is achieved, the coupler (104b) is locked at that position by fastening the first adjuster (206a). The provision of movable coupler (104b) improves feasibility of mounting of the dispensing head (102) on the container (300). In an embodiment, the coupler (104b) is integrated with the dispensing head (102), thereby eliminating the need of the elongated support member (104a). For example, the dispensing head (102) is magnetized, which can be directly mounted on to the outer surface of the container (300). The said coupler (104b) provided on either side of the dispensing head (102) along with the elongated member (104a) is configured to hold the dispensing head (102) abutting/covering the at least one port (302).

In operation, to fumigate the container (300), the dispensing head (202) is mounted on to the outer surface of the container (300) covering the at least one port (302). Using the coupler mechanism (104), the dispensing head (202) is securely held on to the outer surface of the container (300). Further, the apparatus (100) is fluidly connected to the fumigant source (202) through the hose (204). The fumigant gas generated by the fumigant source (202) is supplied to the container (300) through the apparatus (100). The apparatus (100) receives the fumigant gas from the fumigant source (202) and inducts the same to the container (300) through the at least one port (302).

In an embodiment of the disclosure, the apparatus (100) of the present disclosure is suitable to fit any port on any shipping container (300). The provision of coupling mechanism (104) enables easy fixture and removal of the dispensing head (302) of the apparatus on to the outer surface of the container (300).

### EQUIVALENTS

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

List of Reference Numerals:

| | |
|---|---|
| Apparatus | 100 |
| Dispensing head | 102 |
| Base member | 102a |
| Sidewall structure | 102b, 102c, 102d, 102e |
| Coupling mechanism | 104 |
| Elongated support member | 104a |
| Coupler | 104b |
| Slot | 104bs |
| Cross member | 104c |
| Collar | 104cl |
| Cavity | 106 |
| Inlet | 108 |
| Sealing member | 110 |
| System | 200 |
| Fluid source | 202 |
| Fluid supply member | 204 |
| First adjusters | 206a |
| Second adjuster | 206b |
| Container | 300 |
| Port | 302 |

1. An apparatus (100) for supplying fluid from a fluid source (202) to a container (300), the apparatus (100) comprising:
a dispensing head (102) configured to be removably secured to an outer surface of a container (300) and covering at least one port (302) defined in a wall of the container (300), the dispending head (102) is defined with a cavity (106) in fluid communication with the at least one port (302) and configured to receive and supply a fluid from a fluid source (202) to the container (303); and
a coupling mechanism (104) adapted to removably secure the dispensing head (102) on the outer surface of the container (300), the coupling mechanism (104) comprises:
an elongated support member (104a) adapted to adjustably receive the dispensing head (102); and
a coupler (104b) provided on either ends of the elongated support member (104a), wherein the coupler (104b) along with the elongated support member (104a) holds the dispensing head (102) abutting the at least one port (302).

2. The apparatus (100) as claimed in claim 1, wherein the coupler (104b) is selected from a magnetic coupler and a suction coupler.

3. The apparatus (100) as claimed in claim 1, wherein the dispensing head (102) is adjustably secured to the elongated support member (104a) at a substantially central portion.

4. The apparatus (100) as claimed in claim 1, wherein the elongated support member (104a) is defined with slots (104bs) to receive the coupler (104b).

5. The apparatus (100) as claimed in claim 1, wherein the at least one coupler (104b) is adapted to move relative to the slot (104bs) defined in the elongated support member (104a) and is configured to be locked at pre-defined position by the first adjuster (206a).

6. The apparatus (100) as claimed in claim 1, wherein the dispensing head (102) is defined with an inlet port (108) connectable to an outlet of the fluid source (202).

7. The apparatus (100) as claimed in claim 1, wherein the dispensing head (102) is adjustably secured to the elongated support member (104a) by one or more second adjusters (206b).

8. The apparatus (100) as claimed in claim 7, wherein the one or more second adjusters (206b) is configured to adjust at least one of position and height of the dispensing head (102) relative to the elongated support member (104a).

9. The apparatus (100) as claimed in claim 1 further comprising a sealing member (110) provided along a periphery of the dispensing head (102) on a side covering the at least one port (302)

10. A system (200) for supplying fluid to a container (300), the system (200) comprising:
a fluid source (202) configured to supply fluid; and
an apparatus (100) in fluid communication with the fluid source (202) and adapted to receive and supply fluid from the fluid source (202) to the container (300), the apparatus (100) comprises:
a dispensing head (102) configured to be removably secured to an outer surface of a container (300) and covering at least one port (302) defined in a wall of the container (300), the dispending head (102) is defined with a cavity (106) in fluid communication with the at least one port (106) and configured to receive and supply the fluid from the fluid source (202) to the container (303); and
a coupling mechanism (104) adapted to removably secure the dispensing head (102) on the outer surface of the container (300), the coupling mechanism (104) comprises:
an elongated support member (104a) adapted to adjustably receive the dispensing head (102); and
a coupler (104b) provided on either ends of the elongated support member (104a), wherein the at least one coupler (104b) along with the elongated support member (104a) is configured to hold the dispensing head (102) abutting the at least one port (302).

11. The system (200) as claimed in claim 10 further comprising a fluid supply member (204) fluidly connecting an inlet (108) of the dispensing head (102) to an outlet of the fluid source (202).

12. The apparatus (100) as claimed in claim 3, wherein the elongated support member (104a) is defined with slots (104bs) to receive the coupler (104b).
